(19) United States
(12) Patent Application Publication
(10) Pub. No.: US 2019/0248173 A1
(43) Pub. Date: Aug. 15, 2019

(54) FOLDED-BAR IMAGE DISPLAY AND ASSOCIATED METHOD

(71) Applicant: Art Creation and Technology, LLC, San Francisco, CA (US)

(72) Inventors: Hank B. Ridless, San Francisco, CA (US); Peter Croshaw, Paradise, CA (US)

(21) Appl. No.: 15/894,759

(22) Filed: Feb. 12, 2018

(51) Int. Cl. B44D 3/18

(52) U.S. Cl. CPC B44D 3/185

(57) ABSTRACT

An image display is provided comprising: a multiple elongated bars arranged end-to-end to define a frame having a center opening; wherein each bar includes an inner strip, a side strip, and an outer strip and includes a longitudinal inner groove between the inner strip and the side strip and includes a longitudinal outer groove between the outer strip and the side strip; wherein each bar is folded at a longitudinal inner groove, to arrange its inner strip perpendicular to its side strip; wherein each bar also is folded at a longitudinal outer groove, to arrange its outer strip perpendicular to its side strip; multiple cross bars, each securing together inner strips of a pair of bars; and an image substrate that extends across the center opening and overlays and is secured the inner strips and the side strips of each of the multiple bars.

### BACKGROUND

Image displays having wooden stretcher frames have been used by artists as a support structure for their stretched canvases. The look and feel of a stretched canvas over such a frame adds an impression of being genuine stretched canvas artwork. Unfortunately, the cost of a wooden stretcher frame with stretched artist canvas is high for many potential users and buyers of artwork. Many alternative constructions, including those that employ box-like structures that may include top and/or bottom boards, have been developed to simulate the appearance of a wooden stretcher frame and stretched canvas though these generally do not have the fundamental look and feel of the genuine article. There is a need for a new support structure and stretched canvas-like product that retains the look and feel of a stretched canvas image display but that can be produced at significantly lower cost.

### SUMMARY

In one aspect, multiple elongated bars are arranged end-to-end to define a frame having a center opening. An image substrate is extended over the frame and across the opening. An image may be displayed on the image substrate. Each bar includes an inner strip, a side strip, and an outer strip and includes a longitudinal inner groove between the inner strip and the side strip and includes a longitudinal outer groove between the outer strip and the side strip. Each bar is folded at its longitudinal inner groove and secured as folded at its longitudinal inner groove, to arrange its inner strip perpendicular to its side strip. Each bar also is folded at its longitudinal outer groove and secured as folded at its longitudinal outer groove, to arrange its outer strip perpendicular to its side strip. Each bar is arranged in the rectangular frame with its side strip disposed between its folded inner and outer grooves, displaced from the center opening by the inner and outer strips. Fasteners fasten together inner strips of a respective pair of bars. The image substrate overlays the inner strips, the side strips, and the outer strips of each of the multiple bars and is secured to at least one of the inner strips, the side strips, and the outer strips of each of the multiple bars.

In another aspect, a method is provided to produce an image display. Four elongated bars are provided, each including generally planar front and back surfaces and each bar including an inner strip, a side strip, and an outer strip and including a longitudinal inner groove formed in the bar's back surface between the inner strip and the side strip and including a longitudinal outer groove formed in the bar's back surface between the outer strip and the side strip. The four bars are laid out end-to-end in a rectangle frame configuration that defines a center opening, upon a back surface of an image substrate that extends across the opening, with front surfaces down. An inner strip side edge of each bar faces the central opening of the rectangle, and an outer strip side edge of each bar faces away from the center opening, and the bar's side strips are disposed between the inner strips and outer strips. The front surfaces of each of the four bars is adhered to the back surface of the image substrate. An adhesive material is inserted into each bar's inner groove, and each bar is folded at its inner groove to align the bar's side strip and the bar's outer strip perpendicular to the bar's inner strip. An adhesive material is inserted into each bar's outer groove, and each bar is folded at its outer groove to align the bar's side strip and bar's the bar's outer strips perpendicular to each other and to align the bar's outer strip parallel to the bar's inner strip.

### BRIEF DESCRIPTION OF THE DRAWINGS

FIG. 1 is an illustrative rear view of an image display, partially assembled, in accordance with some embodiments.

FIG. 2A is an illustrative drawing of a back face of a first bar of the image display of FIG. 1.

FIG. 2B is an illustrative front face of the first bar of the image display of FIG. 1.

FIG. 2C is an illustrative longitudinal inner side strip view of the first bar of the image display of FIG. 1.

FIG. 3 is an illustrative top elevation view of a corner of a four-bar frame structure of the image display of FIG. 1.

FIG. 4 is an illustrative rear view of the image display of FIG. 1 in which the image substrate has been trimmed in accordance with some embodiments.

FIGS. 5A to 5C are illustrative end edge views of the first bar of the image display of FIG. 1 in a flat, unfolded configuration stage (FIG. 5A), a partially folded intermediate configuration stage (FIG. 5B), and a fully folded C-bar configuration stage (FIG. 5C).

FIG. 6 is an illustrative perspective view the image display of FIG. 1 in the partially folded configuration of FIG. 5-2 in accordance with some embodiments.

FIG. 7 is an illustrative rear perspective outside corner view of the image display of FIG. 1 in the partially folded configuration of FIG. 5-2, showing tucking of a corner flap in accordance with some embodiments.

FIG. 8 is an illustrative rear perspective outside corner view of the image display of FIG. 1 in the fully folded C-bar configuration of FIG. 5-3, showing a tucked-in corner flap in accordance with some embodiments.

FIG. 9A is a perspective front view of the fully assembled rectangular frame of the image display of FIG. 1 in accordance with some embodiments.

FIG. 9B is a perspective front view showing the image substrate overlaying the fully assembled rectangular frame as shown in the view of FIG. 9A in accordance with some embodiments.

FIG. 10A is a perspective back view of the fully assembled rectangular frame of the image display of FIG. 1 in accordance with some embodiments.

FIG. 10B is a perspective back view showing the image substrate overlaying the fully assembled rectangular frame as shown in the view of FIG. 10A, in accordance with some embodiments.

FIG. 11 is an illustrative flow diagram of a method to assemble an image display in accordance with some embodiments.

### DESCRIPTION OF EMBODIMENTS

A rectangular frame structure 100 includes four rigid substantially flat foldable rectangular 102-1 to 102-4 bars arranged end-to-end upon a back surface of an image substrate 104. The image substrate 104 extends over the front surfaces of the bars and also extends across a center opening 902 in the rectangular frame 100. The bars are adhered to the image substrate. Longitudinal grooves 110, 112 formed in back surfaces of the bars segment the bars into at least three strips: inner strips 116, side strips 114, and outer strips 118. The grooves enable folding of the bars into a C-bar structure that includes: inner strips 116 disposed adjacent to the center opening 902 extending parallel to a front face of the image substrate 104 on which an image 904 may be displayed; side bars 114 extending perpendicular from the inner bars 116 at the folded inner grooves 110 and providing an outward facing sides; and outer strips 118 disposed adjacent to the center opening 902 and extending perpendicular to the side strips 114 and parallel to the inner strips 116. Corner cross-bars 302 are secured to respective portions of adjacent inner strips 116 to act as fasteners to secure-together the bars 102-1 to 102-4.

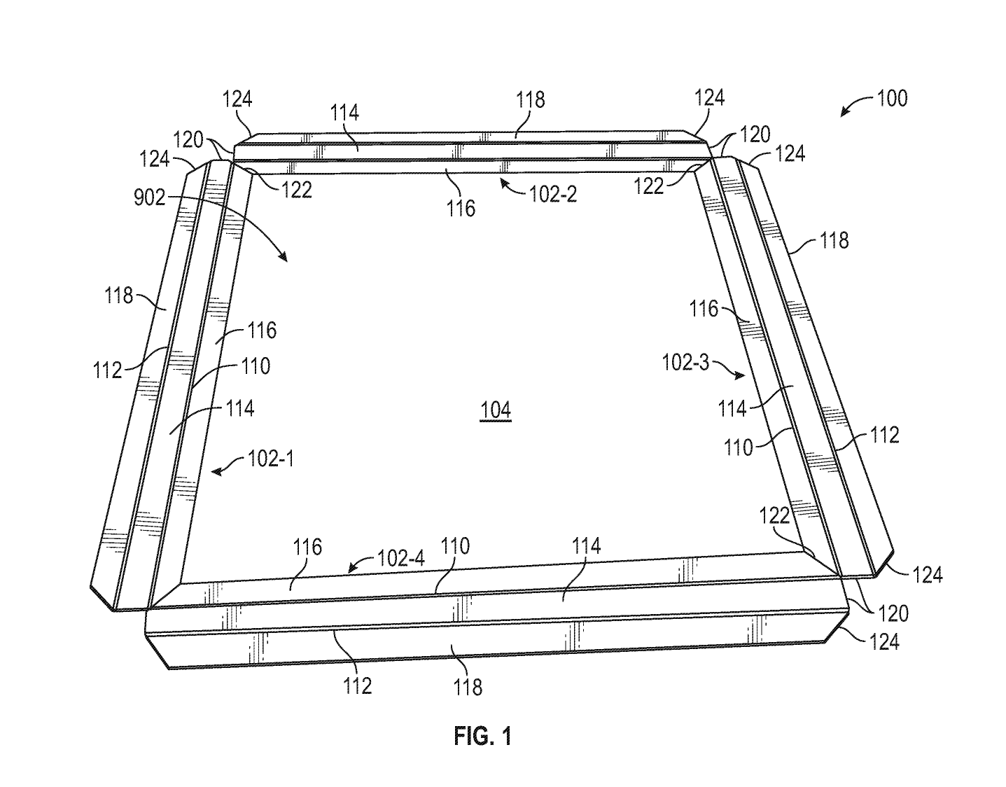

FIG. 1 is an illustrative rear view of an image display 100, partially assembled, in accordance with some embodiments. The partially assembled image display includes four bars. In some embodiments the four bars include, first, second, third and fourth elongated generally longitudinally foldable bars 102-1, 102-2, 102-3 and 102-4 respectively, disposed end-to-end upon a back surface of an image substrate 104, which may include canvas, or paper, paperboard, plastic film, woven or non-woven textiles, for example. In some embodiments, particularly where the rectangular frame is a square, the bars are identical. However, in alternative rectangular frame embodiments in which the frame has opposite sides of different lengths, there may be two pairs of parallel bars, the bars of each pair having different lengths. Moreover, in some alternative embodiments in which the frame is not a rectangle, different bars may have a different length. An image such as a photographic image or painting image may be formed on a front surface (not shown) of the image substrate. Each bar 102-1 to 102-4 is disposed in a flat, unfolded configuration. The four bars are laid out adjacent to one another in a rectangular pattern.

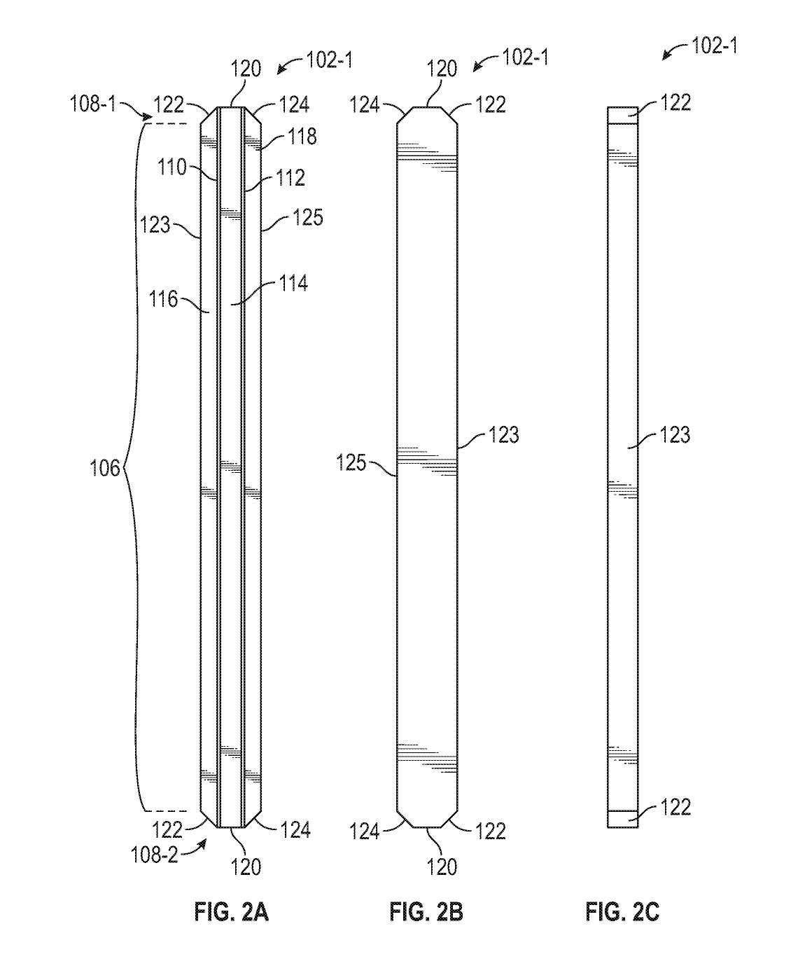

The bars may be formed of a light-weight rigid material from which bars of sufficient strength can be produced such that the bars can be combined into a perimeter frame that exhibits minimal deflection when the frame is displayed on a wall. In some embodiments the bars are formed of fiberboard. Alternatively, the bars may be formed from wood or rigid plastic sheets, paperboard, metal, for example. FIG. 2A is an illustrative drawing of a back face of the first bar 102-1 of FIG. 1. During assembly of the image display, the back face of the first bar 102 faces away from the back face of the image substrate. FIG. 2B is an illustrative front face of the first bar 102-1. During assembly of the image display, the front face of the first bar 102 faces toward and contacts the back face of the image substrate. FIG. 2C is an illustrative longitudinal side view of the first bar 102-1. FIG. 2D is an illustrative end side view of the first bar 102-1.

Referring to FIG. 2A, the first bar 102-1 includes an elongated (longitudinal) portion 106 and first and second end portions 108-1, 108-2 at opposite ends thereof. An inner elongated groove 110 and an outer elongated groove 112 are formed in the elongated portion 106 and extend in parallel with each other for the entire length of the elongated portion 106. The first bar 102-1 is longitudinally foldable along the inner groove 110 and along the outer groove 112. The inner and outer elongated grooves 110, 112 may formed by removal (e.g., by cutting away) of material from where the grooves are to be located. The inner and outer grooves 110, 112 partition the first bar 102-1 into three strips, a side strip 114, an inner strip 116 and an outer strip 118. The side strip 114 is disposed between the inner strip 116 and the outer strip 118. Between the first and second end portions 108-1, 108-2, an inner strip side edge 123 of the inner strip 116 and an outer strip side edge 125 of the outer strip 118 extend parallel to the inner and outer grooves 110, 112 and parallel to each other.

The side strip 114 includes respective straight, side strip end portion edges 120 at opposite ends thereof, that extend between the inner and outer grooves 110, 112, perpendicular to them. The inner strip 116 includes beveled edges 122 at respective opposite end portions thereof that respectively extend between a longitudinal inner strip side edge 123 of the inner strip 116 and respective side strip end portion edges 120 at opposite ends of the first bar 102. More particularly, the respective inner strip beveled end portion edges 122 at opposite end portions of the inner strip 116 extend between the longitudinal inner strip side edge 123 of the inner strip 116 and respective opposite end potions 110-1 of the inner groove 110. In some embodiments, the inner strip beveled end portion edges 122 at respective opposite end portions of the inner strip 116 are slanted at forty-five-degree angles to the longitudinal inner strip side edge 123 of the inner strip 116 and to the respective side strip end portion edges 120 at respective opposite ends of the first bar 102.

The outer strip 118 includes beveled end portion edges 124 at respective opposite end portions thereof that respectively extend between a longitudinal outer strip side edge 125 of the outer strip 118 and respective side strip end portion edges 120 at opposite ends of the first bar 102. More particularly, the respective beveled end portion edges 124 at opposite end portions of the outer strip 118 extend between the longitudinal outer strip side edge 125 of the outer strip 118 and respective opposite end potions 112-1 of the outer groove 112. In some embodiments, the beveled end portion edges 124 at respective opposite end portions of the outer strip 118 are slanted at forty-five-degree angles to the longitudinal outer strip side edge 125 of the outer strip 118 and to the respective side strip end portion edges 120 at respective opposite ends of the first bar 102.

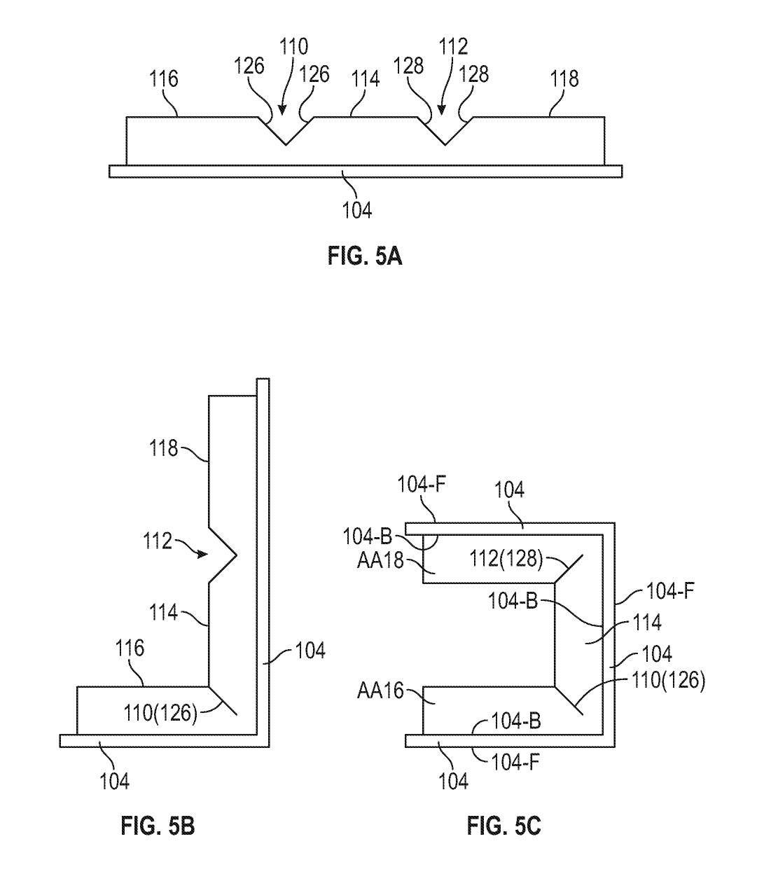

Referring to FIGS. 2B-2C, other than the inner and outer grooves 110, 112, the bar has flat top and bottom surfaces and is thin relative to its length and width. In some embodiments, the bar material may be between 0.060″ and 0.400″ thick and may be reduced in thickness in the grooves to an approximate range of 0.010″ to 0.040″. Referring to FIG. 2B, a front face of the first bar 102-1 has a flat surface that may be adhered to the image substrate 104. Referring to FIG. 5A, the sidewalls 126 of the inner groove 110 are angled relative to the flat front surface of the elongated portion 106. Similarly, the side walls 128 of the outer groove 112 also are angled relative to the flat surface of the elongated portion 106. More particularly, in some embodiments, the sidewalls of the inner groove 110 meet at a forty-five-degree angle to each other, and the sidewalls 128 of the outer groove 112 meet at a forty-five-degree angle to each other.

During the assembly stage shown in FIG. 1, the respective side strips 114, inner strips 116, and outer strips 118 of the four 102-1 to 102-4 are arranged parallel to one another and laid flat upon the back surface of an image substrate 104 such that the beveled end portion edges A22 of the respective inner strips 116 of adjacent bars 102-A02-4 abut against one another to provide rectangular four-bar frame. The frame defines four inner corner regions 130, one for each pair of adjoining inner strip beveled end portion edges A22. The side strip end portion edges 120 of adjacent bars do not abut while the center, inner, and outer strips 114, 116, 118 are laid out in parallel. The outer strip end portion edges 124 of adjacent bars do not abut while the center, inner, and outer strips 114, 116, 118 are laid out in parallel.

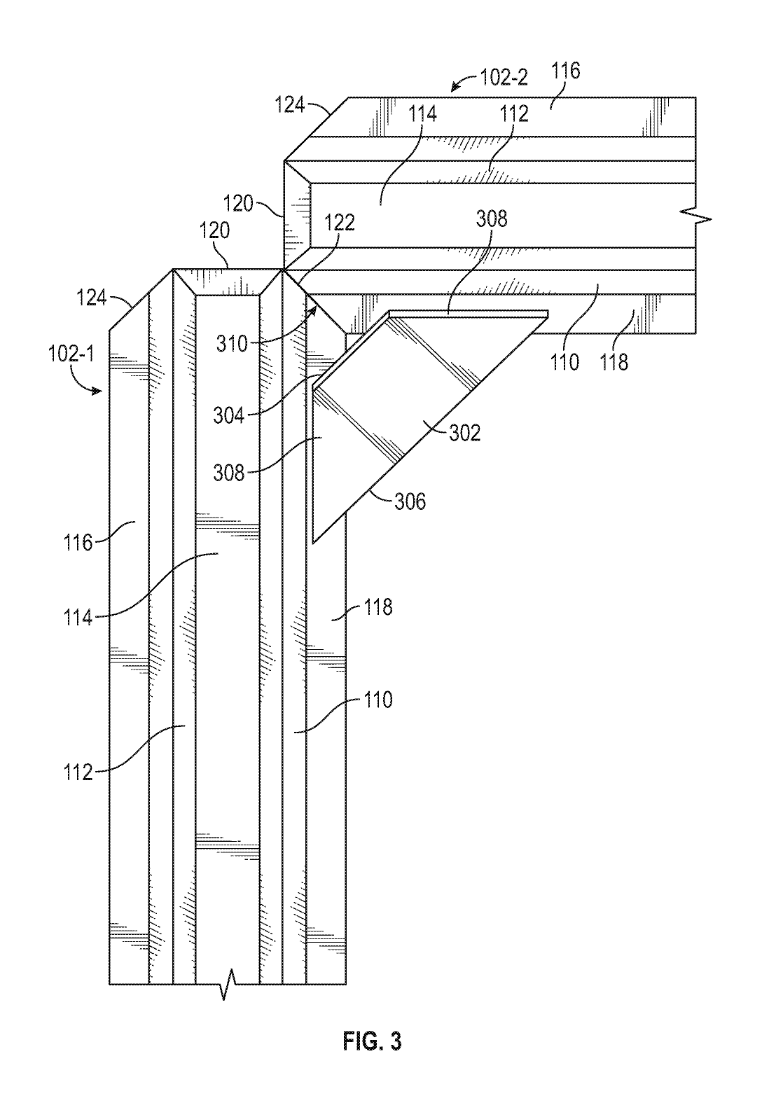

FIG. 3 is an illustrative top elevation view of a corner of the four-bar frame configured in a flat configuration showing abutting beveled end portion edges 122 of adjacent inner strips 116 of a pair of adjacent bars 102-1, 102-2. A corner cross-bar support 302 extends across the corner region 130 formed by the adjoining inner strip beveled end portion edges 122. The corner cross-bar 302 is secured to respective back faces of portions of the adjacent inner strips 116 at the corner region 130. The corner cross-bar 302 may be secured using an adhesive such as glue or using a fastener such as a staple, for example. The corner cross-bar 302 may be formed of wood or plastic or metal, for example.

The corner cross-bar 302 includes opposed parallel inner-facing edge portions and outer-facing edge portions 304, 306, respectively. The inner-facing edge portion 304 faces inward toward an interior of the rectangular frame. The outer-facing edge portion 306 faces outward from the interior of the rectangular frame, toward the abutting beveled end portion edges 122 of adjacent inner strips 116. The corner-cross-bar 302 includes opposed beveled end portion edges 308 extending between the inner-facing and outer-facing edge portions 304, 306 of the corner cross-bar C002. The inner-facing edge portion 304 is shorter than the outer-facing edged portion 306, and the opposed beveled end portion edges 308 extend at a slant between them. In some embodiments, the opposed beveled end portion edges 308 extend perpendicular to each other at a slant between the inner and outer facing edge portions 304, 306. The corner cross-bar is positioned such that its opposed beveled edge portions 308 overlay portions of the adjacent inner strips 116 adjacent to the corner region 130 and extend parallel to the inner grooves of the adjacent bars 102-1, 102-2, which are arranged perpendicular to each other. The outer-facing edge 308 extends between the inner strips 116 of the adjacent bars 102-1, 102-2. The inner-facing edge 306 is spaced apart from the abutting inner strips 116 so as define a gap 310 between the inner-facing edge 306 and the abutting inner strips 116. The corner cross-bar 302 may fully fill the corner opening or it may partially fill the corner opening (as illustrated in FIG. 3) so that there is a gap into which the canvas may be pushed. The corner cross bar 302 also may be other shapes including squares/rectangles that contacts to the inner strips 116.

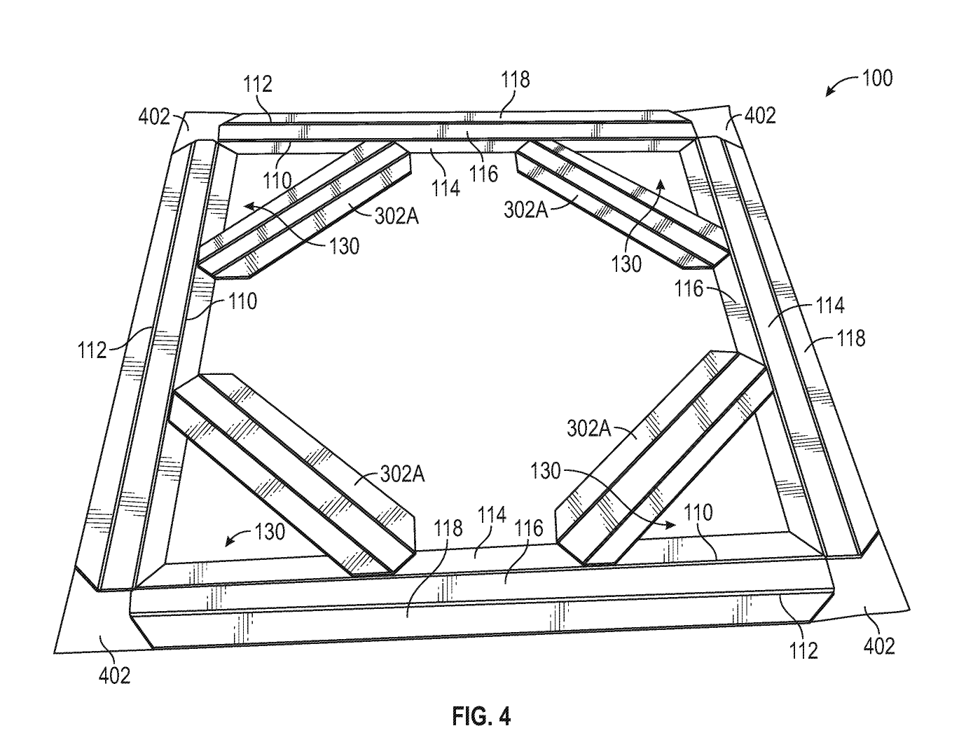

FIG. 4 is an illustrative rear view of the partially assembled image display 100 of FIG. 1 in which the image substrate 104 has been trimmed to a match shape a shape of the frame structure 100, in accordance with some embodiments. The image substrate may be stretched to tension the image substrate so lay taught and flat beneath the bars. An adhesive material such as glue, for example, may secure a front face (not shown) of one or more of the center, inner, and outer strips 114, 116, 118 is secured to the back surface of an image substrate 104. More particularly, the image substrate 104 may be trimmed so that it's respective outer edges align with respective longitudinal outer strip side edges 125 of the outer strips 118 of the bars 102-1 to 102 to 102-4. Moreover, the image substrate 104 may be trimmed to provide at each of its corners, a generally triangular corner flap 402 that extends free. That is, the end flap 402 extends beyond and is not overlaid by side strip edge portions 120 and extends beyond and is not overlaid by beveled inner strip end portion edges 122 near adjoining corner regions 130 of the frame.

It is noted that in the embodiment of FIG. 4, alternative corner cross-bar supports 302A are provided that are offset further from the rectangle corner regions 130. The cross-bar supports 302A may be secured to the back surfaces of adjacent inner strips 116 to secure them together.

FIGS. 5A to 5C are illustrative end edge views of the first bar 102-1 in three folding stages, starting from a flat, unfolded configuration stage (FIG. 5A), followed by a partially folded intermediate configuration stage (FIG. 5B), followed by a fully folded C-bar configuration stage (FIG. 5C). In the flat, unfolded configuration of FIG. 5A, the side strip 114, inner strip 116 and outer strip 118 are arranged flat, side-by-side, separated by the inner groove 110 and the outer groove 112. To transition the first bar 102-1 from the unfolded configuration of FIG. 5A to the partially folded configuration of FIG. 5B, the first bar 102 is folded along the inner groove 110 to change the relative positions of the side, inner, and outer strips 114, 116, 118 by moving the sidewalls 126 of the inner groove 110 into contact with one another so as to configure the inner strip 116 perpendicular to the side and outer strips 114, 118, which remain parallel to each other on opposite sides of the outer groove 112. Prior to folding the sidewalls 126 of the inner groove 110 into contact, an adhesive material such as glue, for example, may be inserted within the inner groove 110 to hold the inner and side strips 116, 114 securely, fixed in the partially folded configuration. To transition the first bar 102-1 from the partially folded configuration of FIG. 5B to the fully folded C-bar configuration of FIG. 5C, the first bar 102 is folded along the outer groove 112 to change the relative positions of the side, inner, and outer strips 114, 116, 118 by moving the sidewalls 128 of the outer groove 112 into contact with one another so as to configure the outer strip 118 perpendicular to the side strip 114 and parallel to the inner strip 118. Prior to folding the sidewalls 128 of the outer groove 112 into contact, the adhesive material may be inserted within the outer groove 112 to hold the side and outer strips 114, 118 securely, fixed in the C-bar configuration. In some embodiments, an adhesive strip (not shown) may be placed on the two inner surfaces of the contiguous strips so that the adhesive will form a solid element that joins these two strips without the adhesive being inserted within the groove.

In the C-bar configuration, the inner and outer strips 116, 118 are separated by the side strip 114. The image substrate 104 is secured to, wraps about and is held taught by the C-bar shaped frame. More specifically, a back surface 104-B of the image substrate 104 overlays and a front surface 104-F of the image substrate 104 faces opposite the side, inner and outer strips 114, 116, 118.

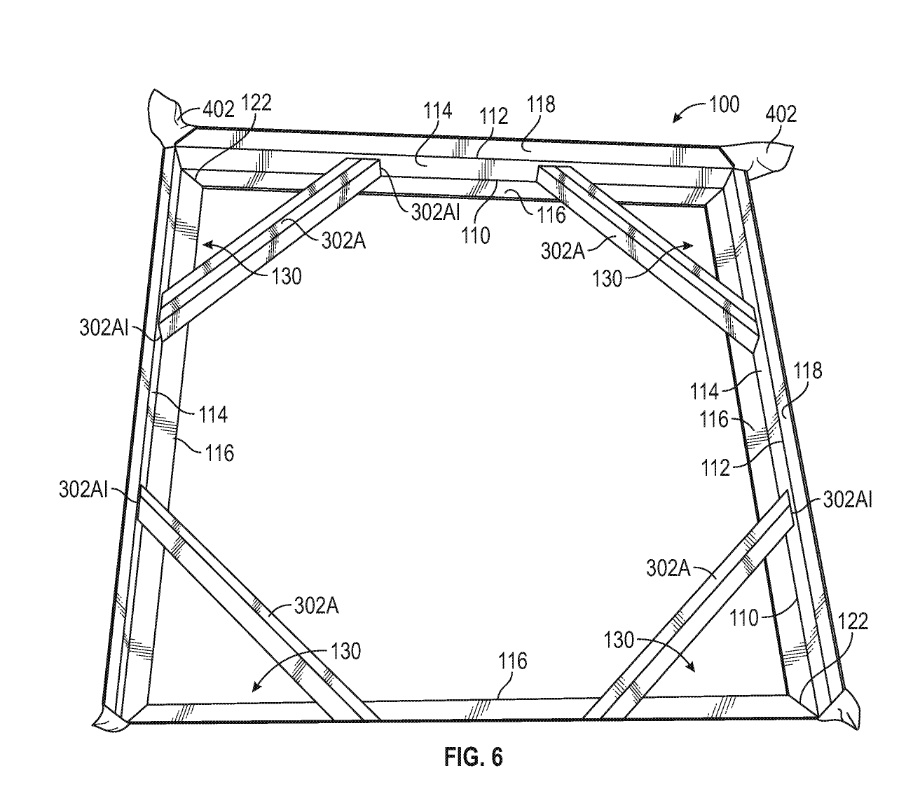

FIG. 6 is an illustrative perspective view the image display 100 of FIG. 1 in the partially folded configuration of FIG. 5-2 in accordance with some embodiments. The inner grooves 110 of the four bars 102-1 to 102-4 are folded to a folded closed position with side walls 126 in contact such that the side strips 114 upstand perpendicular to the inner strips 122 and such that the side strip end portion edges 120 of adjacent side strips A14 abut against each other. The beveled end portion edges 122 of adjacent inner strips 116 abut against each other. The outer strips 118 extend parallel to their corresponding side strips 114 and the outer strip end portion edges 124 do not abut against each other, since the outer grooves 112 of the four bars 102-1 to 102-4 are not yet folded to the closed position.

It is noted that in the embodiment of FIG. 6, alternative corner cross-bar supports 302B are provided that are offset further from the rectangle corner regions 130. The cross-bar supports 302B include beveled end portions 302B1 that are slanted to abut against outer faces of the upstanding side strips 114 to provide structural support thereto. The cross-bar supports 302B may be secured to both the back surfaces of adjacent inner strips 116 and to back surfaces of adjacent side strips 114 to provide additional strength.

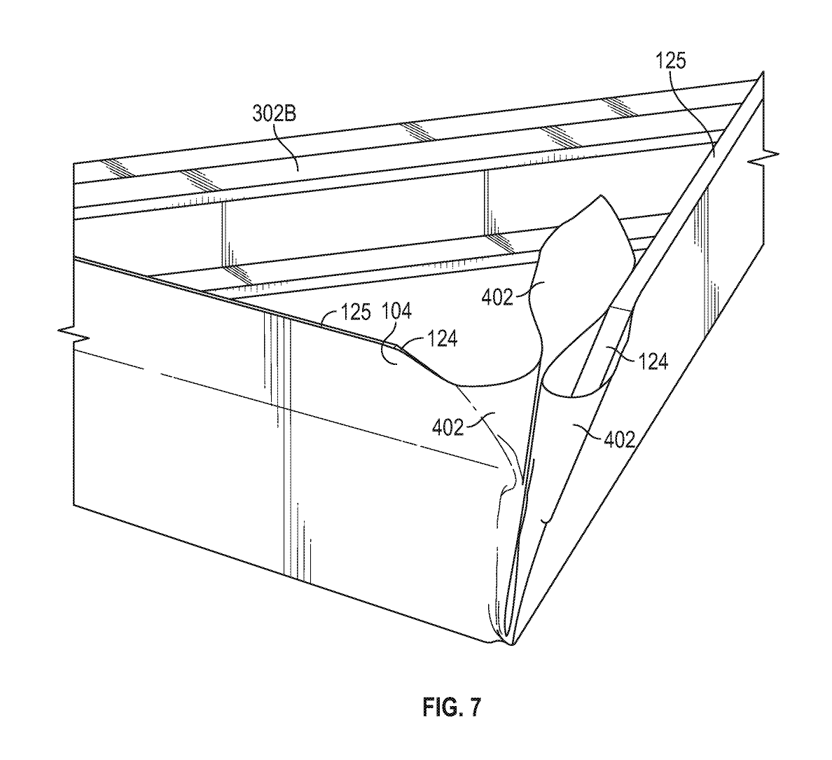

FIG. 7 is an illustrative rear perspective outside corner view of the image display 100 in the partially folded configuration of FIG. 5-2, showing tucking of a corner flap 402 between side strip end portion edges 120 and outer strip end portion edges 124 of adjacent bars. The embodiment of FIG. 7 includes corner cross-bar supports 302B. The adjacent strip end portion edges 120 and outer strip end portion edges 124 extend parallel to each other since the outer grooves 112 have not yet been folded to a closed position. The strip end portion edges 120 and outer strip end portion edges 124, which are disposed behind the image substrate 104, are indicated, in part, by dashed lines. In accordance with some embodiments. A portion of the corner flap 402 extends between the adjacent strip end portion edges 120 and outer strip end portion edges 124 to the gap 310 between the inner-facing edge 306 of the corner cross-bar support 302 and the abutting inner strips 116. The corner flap D002 may be pushed in between the adjacent side strip end portion edges 120 during the folding of the bars from the unfolded configuration of FIG. 5-1 to the partially folded configuration of FIG. 5-2. The flap 402 is frictionally gripped between abutting adjacent side strip end portion edges 120. While the bars are in the partially folded configuration, adjacent beveled outer strip end portion edges 124 are spaced apart, and therefore, are not yet gripped between them.

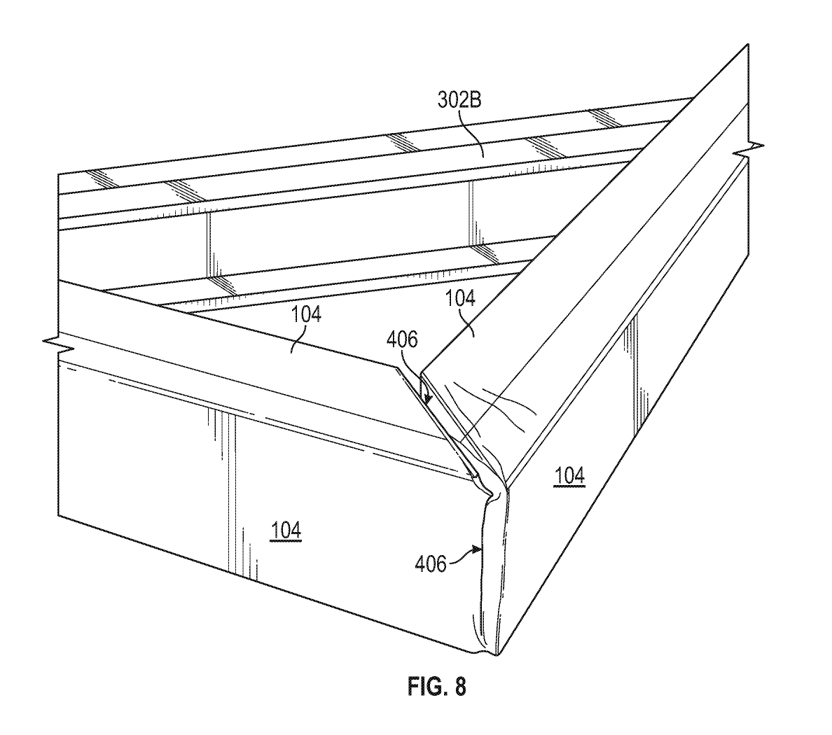

FIG. 8 is an illustrative rear perspective outside corner view of the image display 100 in the fully folded C-bar configuration of FIG. 5-3, showing a corner flap 402 tucked between strip end portion edges 120 and outer strip end portion edges 124 of adjacent bars. The embodiment of FIG. 8 includes corner cross-bar supports 302B. The adjacent side strip end portion edges 120 and outer strip end portion edges 124 extend perpendicular to each other since the outer grooves 112 have been folded to the closed position. The corner flap 402 may be pushed in between the adjacent outer strip end portion edges 124 during the folding of the bars from the partially folded configuration of FIG. 5-2 to the fully folded C-bar configuration of FIG. 5-3. The flap 402 is frictionally gripped between abutting adjacent outer strip end portion edges 124.

Still referring to FIG. 8, in the fully folded C-bar configuration the contour of the image substrate 104 conforms to the contour of the underlying rectangular C-bar frame. A back portion of the image substrate 104 that overlays the back strips 118 (not visible) conforms to the contour of the back strips which are hidden behind the image substrate 104. A side portion of the image substrate that overlays the side strips conforms 114 (not visible) conforms to a contour of the side strips which are hidden behind the image substrate 104. The abutting strip end portion edges 120 and outer strip end portion edges 124 frictionally capture the corner flap 402 cleanly and neatly between them as indicated by the corner flap end seam 406 between them.

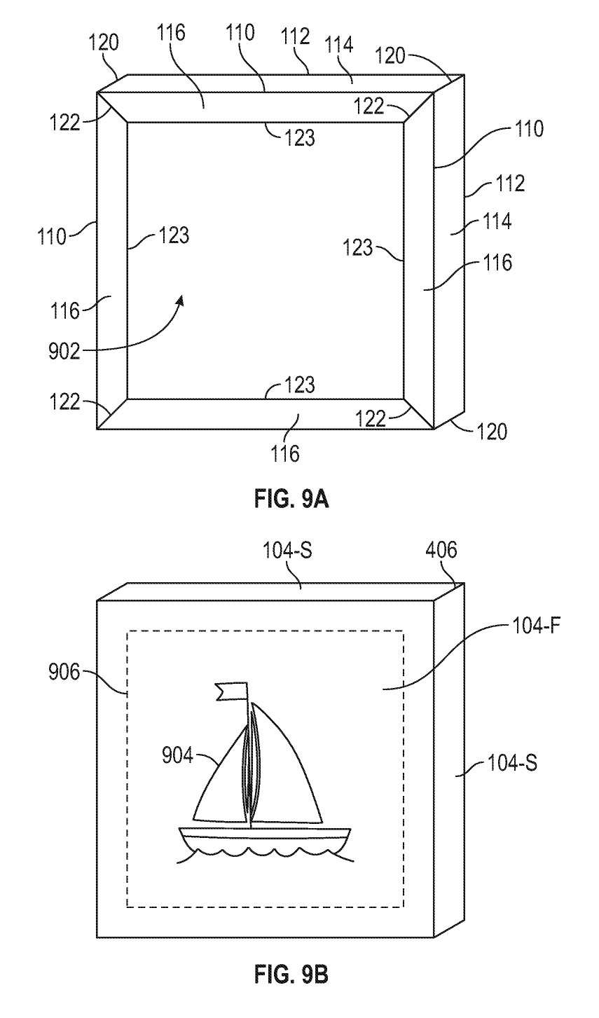

FIG. 9A is a perspective front view of the fully assembled rectangular frame of the image display of FIG. 1 with fully-folded C-bars fully, in accordance with some embodiments. The image substrate is not shown so as to reveal the underlying frame structure. The smooth front surfaces of the four side strips 114 that abut at straight side strip end portion edges 120, provide an outer perimeter that may be overlaid by the image substrate (not shown). Four inner strips 116 that abut at beveled end portion edges 122, extend perpendicular to and inwardly from the inner folded grooves 110 to provide an inner front perimeter. The inner strip side edges 123 face inward toward the center opening 902. The inner strips 116 surround a rectangular center opening 902 across which the image substrate may extend. The side strips 114 are disposed between the folded inner and outer grooves 110, 112 and are displaced from the center opening 902 by the inner and outer strips 116, 118.

FIG. 9B is a perspective front view showing the image substrate 104 overlaying the fully assembled rectangular frame as shown in the view of FIG. 9A, in accordance with some embodiments. The image substrate 104 overlays and conforms to the contours of the fully folded four C-bar rectangular frame structure of FIG. 9A. An image substrate front portion 104-F overlays the center opening 902 and the inner strips 116 (not visible). An image 904 may be formed on a front side of the front portion 104-F. Dashed lines 906 indicate the location of the underlying hidden inner strips 116 that extend parallel to and in contact with the planar image substrate front portion 104-F. An image substrate side portion 104-S overlays and conforms to the contours of side strips (not shown) hidden behind it. Image substrate corner flap seams 406 are neatly tucked between adjacent side strips (not shown) across which the image substrate 104 to provide a clean appearance. There are no tucked seams on the image substrate front portion 104-F, which adds to the clean appearance.

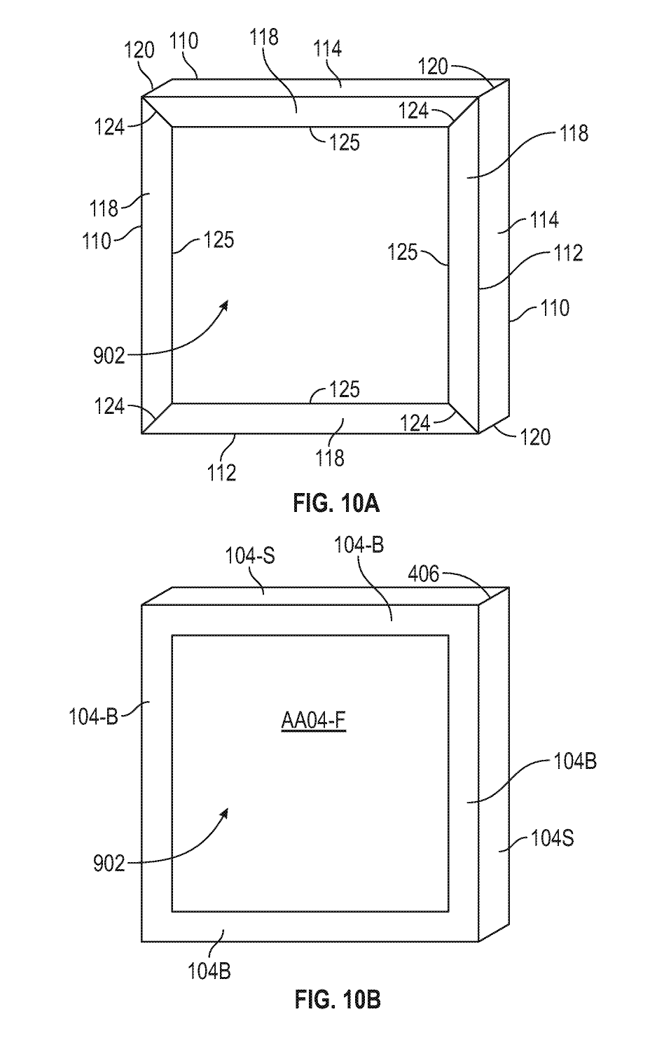

FIG. 10A is a perspective back view of the fully assembled rectangular frame of the image display of FIG. 1 with fully-folded C-bars fully, in accordance with some embodiments. The image substrate is not shown so as to reveal the underlying frame structure. As explained above, the smooth front surfaces of the four side strips 114 that abut at straight side strip end portion edges 120, provide the outer perimeter that may be overlaid by the image substrate (not shown). Four outer strips 118 that abut at beveled end portion edges 124, extend perpendicular to and inwardly from the outer folded grooves 112 to provide an inner back perimeter. The outer strips 118 surround the rectangular center opening 902 across which the image substrate may extend, offset from the outer strips 118 by the widths of the side strips 114. The outer strip side edges 125 face inward toward the center opening 902. The side strips 114 are disposed between the folded inner and outer grooves 110, 112 and are displaced from the center opening 902 by the inner and outer strips 116, 118.

FIG. 10B is a perspective back view showing the image substrate 104 overlaying the fully assembled rectangular frame as shown in the view of FIG. 10A, in accordance with some embodiments. The image substrate 104 overlays and conforms to the contours of the fully folded four C-bar rectangular frame structure of FIG. 10A. An image substrate back portion 104-B overlays and follows the contour of the outer strips 118 (not visible). As explained above, the image substrate side portion 104-S overlays and conforms to the contours of side strips (not visible) hidden behind it. The image substrate back portion 104-B surrounds the rectangular center opening 902. A back surface of the image substrate front portion 104-F is offset from the image substrate back portion 104-B by the width of the side strips 104 (not visible).

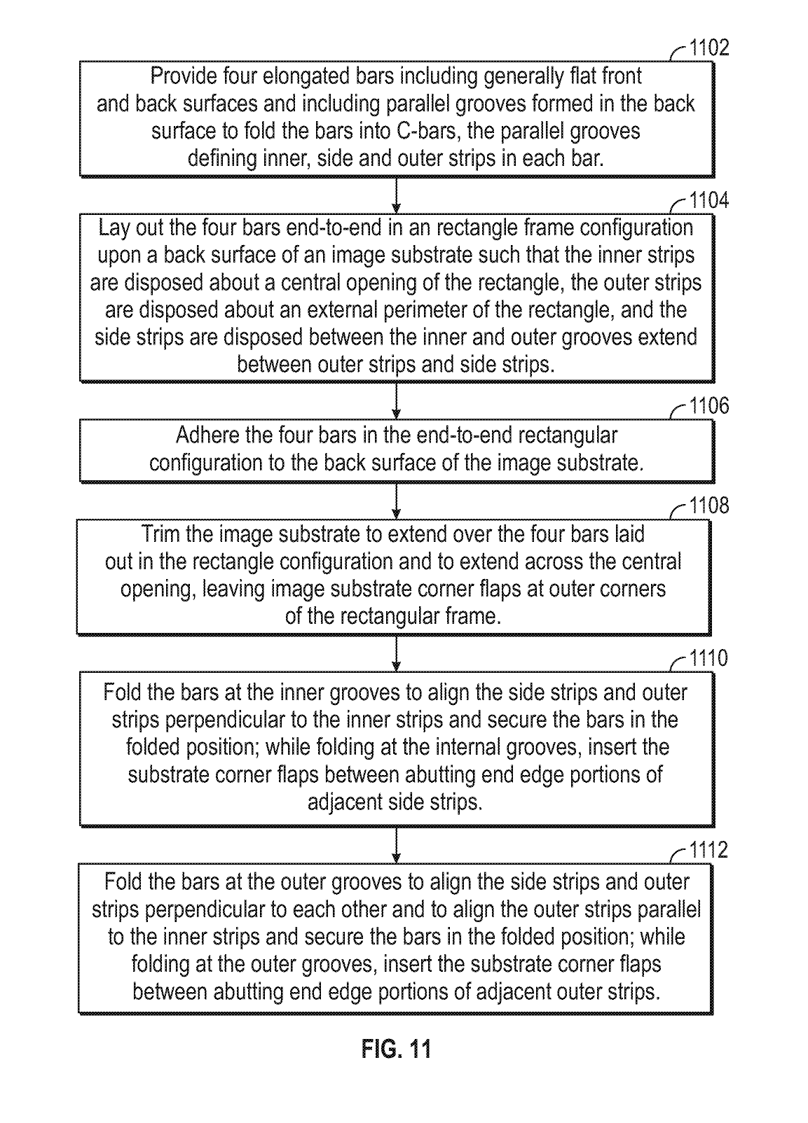

FIG. 11 is an illustrative flow diagram of a method to assemble an image display in accordance with some embodiments. In a first step 1102, four elongated bars 102-1 to 102-4 are provided that include generally flat front and back surfaces and include parallel inner and outer grooves 110, 112 formed in the back surface to fold each of the bars 102-1 to 102-4 into a C-bar configuration. The parallel inner and outer grooves 110, 112 define an inner strip 116, side strips 114 and outer strips 118. In step 1104 the bars are laid out end-to-end in an rectangle frame configuration upon a back surface of an image substrate 104 such that the inner strips 116 are disposed about a central opening 902 of the rectangular frame, the outer strips 118 are disposed about an external perimeter of the rectangular frame, and the side strips 114 are disposed between the inner and outer strips 116, 118, and such that the inner grooves 110 extend between inner strips 116 and side strips 114, and the outer grooves 112 extend between outer strips 118 and side strips 114. In step 1106, the four bars in the end-to-end rectangular configuration are adhered to the back surface (i.e. a surface facing away from an image-displaying surface) of the image substrate 104. In some embodiments, the laying out and adhering steps may occur contemporaneously. In step 1108, the image substrate may be trimmed to substrate extend over the four bars laid out in the rectangle configuration and extends across the central opening. In some embodiments image substrate corner flaps may extend outward at outer corners of the rectangular frame. In some embodiments, trimming step may occur before the step of laying out the bars upon it. In step 1110, an adhesive material is inserted into the internal grooves 110, and the bars 102-1 to 102-4 are folded at the internal grooves 110 to align the side strips 114 and outer strips 118 perpendicular to the inner strips 116. During step 1110, while folding at the internal grooves 110, substrate corner flaps 406 may be inserted between abutting end edge portions 120 of adjacent side strips 114. In step 1112, adhesive material is inserted into the outer grooves 112, and the bars 102-1 to 102-4 are folded at the outer grooves 118 to align the side strips 114 and outer strips 118 perpendicular to each other and to align the outer strips 118 parallel to the inner strips 116. During step 1112, while folding at the outer grooves 112, substrate corner flaps 406 may be inserted between abutting end edge portions 124 of adjacent outer strips 118.

This description is presented to enable any person skilled in the art to create and use an image display. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. Identical reference numerals are used to represent different views of the same item in different drawings. Thus, the present invention is not intended to be limited to the embodiments shown, but is to be accorded the widest scope consistent with the principles and features disclosed herein.

Although the present invention has been described in connection with some embodiments, it is not intended to be limited to the specific form set forth herein. One skilled in the art would recognize that various features of the described embodiments may be combined in accordance with the invention. For example, a rigid member such as a cross-bar or back panel (not shown) may extend across at least a portion of the opening 902, secured to front faces of two or more inner strips to provided added rigidity. In that alternative, the image substrate might not extend to completely cover the front surface of the inner strips 116 so that the rigid member may be adhered directly to the inner strip front surface. Also, for example, an additional (third) longitudinal groove may be formed in the bars so that they may be folded thrice to produce four-sided “D-bars” for added strength. It will be appreciated that a three-sided C-bar structure may be included within a four-sided D-bar structure. Also, for example, cross-bars that are offset further from the inner corner regions 130 may be provided in addition to or in place of the corner cross-bars 302, 302A, 302B. Moreover, it will be appreciated that various modifications and alterations may be made by those skilled in the art without departing from the scope of the invention.

1. An image display comprising:
multiple elongated bars arranged end-to-end to define a frame structure having a center opening;
wherein each bar includes an inner strip, a side strip, and an outer strip and includes a longitudinal inner groove between the inner strip and the side strip and includes a longitudinal outer groove between the outer strip and the side strip;
wherein each bar is folded at its longitudinal inner groove and secured as folded at its longitudinal inner groove, to arrange its inner strip perpendicular to its side strip;
wherein each bar also is folded at its longitudinal outer groove and secured as folded at its longitudinal outer groove, to arrange its outer strip perpendicular to its side strip;
wherein each bar is arranged with its side strip disposed between its folded inner and outer grooves, displaced from the center opening by the inner and outer strips; further including:
fasteners to fasten together inner strips of a respective pair of bars; and
an image substrate that extends across the center opening, that overlays the inner strips and the side strips of each of the multiple bars and that is secured to at least one of the inner strips and the side strips of each of the multiple bars.

2. The image display of claim 1,
wherein the bars are arranged end-to-end to define a rectangular frame structure.

3. The image display of claim 1,
wherein the fasteners include multiple cross bars, each respective cross-bar extending between inner strips of a respective pair of bars.

4. The image display of claim 1,
wherein each bar includes an inner strip that includes beveled edges at opposite ends thereof.

5. The image display of claim 1,
wherein each bar includes an outer strip that includes beveled edges at opposite ends thereof.

6. The image display of claim 1,
wherein each bar includes an inner strip that includes beveled edges at opposite ends thereof and includes an outer strip that includes beveled edges at opposite ends thereof and includes a side strip that includes edges at opposite ends thereof that are perpendicular to the inner and outer grooves.

7. The image display of claim 1 further including:
adhesive material to secure each bar's side strip perpendicular to the bar's inner strip; and
adhesive material to secure each bar's side strip perpendicular to the bar's outer strip.

8. The image display of claim 1,
wherein the bars are substantially rectangular.

9. The image display of claim 1,
wherein the image substrate overlays at least a portion of the outer strips.

10. An image display comprising:
a four C-bars arranged end-to-end to define a rectangular frame having a center opening;
wherein each C-bar includes an inner strip, a side strip, and an outer strip and includes a longitudinal inner groove between the inner strip and the side strip and includes a longitudinal outer groove between the outer strip and the side strip;
wherein each bar is folded at its longitudinal inner groove to arrange its inner strip perpendicular to its side strip;
wherein each bar is folded at its longitudinal outer groove to arrange its outer strip perpendicular to its side strip;
wherein each bar is arranged with its side strip disposed between its folded inner and outer grooves, displaced from the center opening by the inner and outer strips; further including:
an adhesive disposed to secure the bar's inner strip perpendicular to the bar's side strip;
an adhesive disposed to secure the bar's outer strip perpendicular to the bar's side strip
fasteners to secure together inner strips of a different pair of bars;
an image substrate extending across the center opening and disposed in contact with the inner strips and the side strips of the multiple bars and;
wherein the image substrate is secured to at least one of the inner strips and the side strips of each of the multiple bars.

11. The image display of claim 10,
wherein the fasteners include multiple cross bars, each respective cross-bar extending between inner strips of a respective pair of bars.

12. The image display of claim 10,
wherein each bar includes an inner strip that includes beveled edges at opposite ends thereof and includes an outer strip that includes beveled edges at opposite ends thereof and includes a side strip that includes edges at opposite ends thereof that are perpendicular to the inner and outer grooves.

13. The image display of claim 10 further including:
adhesive to secure each bar's side strip perpendicular to the bar's inner strip; and
adhesive to secure each bar's side strip perpendicular to the bar's outer strip.

14. The image display of claim 1,
wherein the image substrate overlays at least a portion of the outer strips.

15. An image display comprising:
multiple elongated rectangular bars arranged end-to-end to define a frame having a center opening;
wherein each bar includes an inner strip, a side strip, and an outer strip and includes a longitudinal inner groove between the inner strip and the side strip and includes a longitudinal outer groove between the outer strip and the side strip;
wherein each bar is folded at its longitudinal inner groove to arrange its inner strip perpendicular to its side strip;
wherein each bar is folded at its longitudinal outer groove to arrange its outer strip perpendicular to its side strip;
wherein each bar includes two end edge portions, and each bar is arranged in the rectangular frame so that its two end edge portions abut against an end edge portion of each of two other bars adjacent to the bar in the rectangular frame;
wherein each inner strip includes a longitudinal inner strip side edge and each bar is arranged so that a longitudinal inner strip side edge of its inner strip, faces inward toward the center opening;
wherein each outer strip includes a longitudinal outer strip side edge and each bar is arranged that a longitudinal outer strip side edge of its outer strip, faces inward toward the center opening;
wherein each bar is arranged with its side strip disposed between its folded inner and outer grooves, displaced from the center opening by the inner and outer strips; further including:
an adhesive disposed to secure the bar's inner strip perpendicular to the bar's side strip;
an adhesive disposed to secure the bar's outer strip perpendicular to the bar's side strip
multiple cross bars, each securing together inner strips of a different pair of bars;
an image substrate extending across the center opening and disposed in contact with the inner strips and the side strips;
wherein the image substrate is secured to at least one of the inner strips and the side strips of each of the multiple bars.

16. A method to produce an image display comprising:
providing four elongated bars, each including generally planar front and back surfaces and each bar including an inner strip, a side strip, and an outer strip and including a longitudinal inner groove formed in the bar's back surface between the inner strip and the side strip and including a longitudinal outer groove formed in the bar's back surface between the outer strip and the side strip;
laying out the four bars end-to-end in a rectangle frame configuration that defines a center opening, upon a back surface of an image substrate that extends across the opening, with front surfaces down, such that for each bar, its inner strip side edge faces the central opening of the rectangle, its outer strip side edges face away from the center opening, and its side strips are disposed between the inner strips and outer strips;
adhering the at least a portion of the front surfaces of each of the four bars, laid out in the end-to-end rectangular configuration, to the back surface of the image substrate;
folding each bar at its inner groove to align the bar's side strip and the bar's outer strip perpendicular to the bar's inner strip and securing the bar's side strip perpendicular to the bar's inner strip; and
folding each bar at its outer groove to align the bar's side strip and the bar's outer strips perpendicular to each other and to align the bar's outer strip parallel to the bar's inner strip and securing the bar's side strip perpendicular to the bar's outer strip.
